(19) United States
(12) Patent Application Publication
(10) Pub. No.: US 2004/0264456 A1
(43) Pub. Date: Dec. 30, 2004

(54) Interoperability of presence services with wireless village and IP multimedia subsystem standards

(75) Inventors: Mark Beckmann, Braunschweig (DE); Hyung-Nam Choi, Hamburg (DE); Achim Luft, Braunschweig (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/798,883

(22) Filed: Mar. 12, 2004

(30) Foreign Application Priority Data
Mar. 14, 2003 (EP) 03005848.1

(51) Int. Cl. H04L 12/56

(52) U.S. Cl. 370/389

(57) ABSTRACT

A simple and efficient opportunity for interoperability of the presence services in line with the Wireless Village and IP Multimedia Subsystem standards is described by the method and the apparatus for recording presence attributes from the Wireless Village standard in a presence information message from the IP Multimedia Subsystem standard in a mobile communication network. At least one text character string in a presence attribute from the Wireless Village standard is recorded by a mapping unit in a note element in a presence information message from the IP Multimedia Subsystem standard, and the presence information message is transmitted to a presence server for the purpose of forwarding to further network units.

### CLAIM FOR PRIORITY

This application claims the benefit of priority to European Application No. 03005848.1, filed in the German language on Mar. 14, 2003, the contents of which are hereby incorporated by reference.

### TECHNICAL FIELD OF THE INVENTION

The invention relates to a method and an apparatus for recording presence attributes from the Wireless Village standard in a presence information message from the IP Multimedia Subsystem standard in a mobile communication network.

### BACKGROUND OF THE INVENTION

In a mobile communication network, there are a plurality of standards relating to polling for presence information for a mobile radio terminal and its user. At present, the Wireless Village (WV) standard and the 3GPP IP Multimedia Subsystem (IMS) standard are used. The Wireless Village standard defines a large number of explicit attributes for a mobile radio terminal or a user of a mobile radio terminal. Some of these attributes have a text character string as the value range. The attributes used in the 3GPP IMS presence service are based on a solution specified in the IETF (Internet Engineering Task Force), the specification being in draft-ietf-impp-cpim-pidf. This stipulates that presence information insist upon the following individual information items:

an identifier for the user of a mobile radio terminal,

one or more “presence tuples”one or more “note elements” which can contain text information.

To date, it has not been possible for a mobile radio terminal which supports only the 3GPP IMS standard to poll even so for presence information from users of a mobile radio terminal which supports only the WV standard, and vice versa. The 3GPP specification 23.141 [1] currently only describes the fact that a network may contain a network unit which performs transposition from one standard to the other. However, the specification does not describe what the appearance of such transposition might be.

### SUMMARY OF THE INVENTION

The present invention relates to the interoperability of presence services in line with the Wireless Village standard and the 3GPP IP Multimedia Subsystem Standard.

In one embodiment of the invention, attributes from the WV standard, which are represented using text character strings, are recorded in note elements in a presence information message from the IMS standard. In addition, the text character string in the note element is provided with a supplement relating to an opportunity for clear association with the presence attribute from the Wireless Village standard, which is separated from the text character string by virtue of a separating character (e.g. a colon). The supplement could comprise, by way of example, the name of the attribute, and allows the text character strings to be converted back into WV attributes. One advantage of the invention is that network providers are afforded the opportunity to use an IMS presence server for presence information and nevertheless to be able to operate mobile radio terminals which support the WV standard.

### BRIEF DESCRIPTION OF THE DRAWINGS

The invention is explained in more detail using an exemplary embodiment which is illustrated in the figures, in which, specifically,

FIG. 1 shows a table A with attributes in line with the WV standard.

FIG. 2 shows a table B of the recorded text character strings in note elements.

FIG. 3 shows a simplified network architecture.

FIG. 4 shows a table C of the presence information.

FIG. 5 shows the sequence for how the mobile radio terminal polls for the information stored on the presence server.

### DETAILED DESCRIPTION OF THE INVENTION

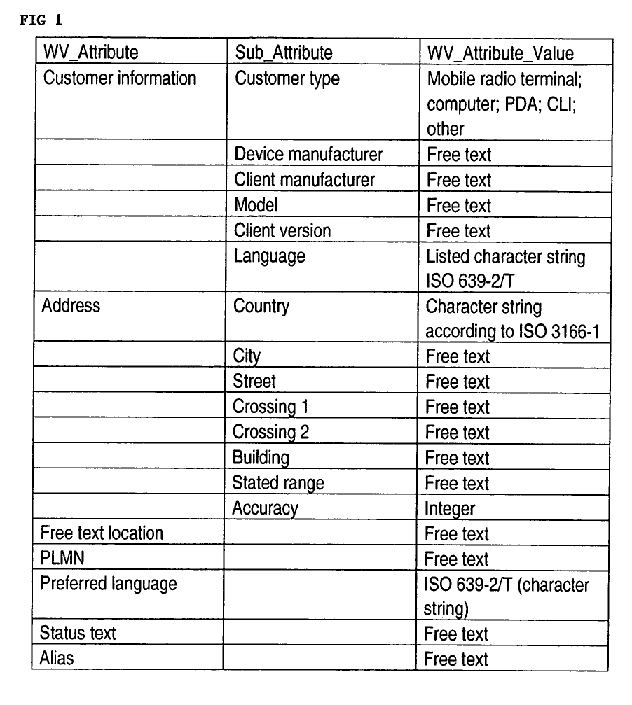

FIG. 1 shows a table including the attributes in line with the WV standard, which can be represented in a form of text character strings in the note elements in the IMS presence information. As can be seen in the last column, the value range for the customer type, for the language attribute, for the country and for the accuracy of the address attribute involves stipulated values, i.e. values other than those indicated are not permissible. The value range is represented in the form of a text character string.

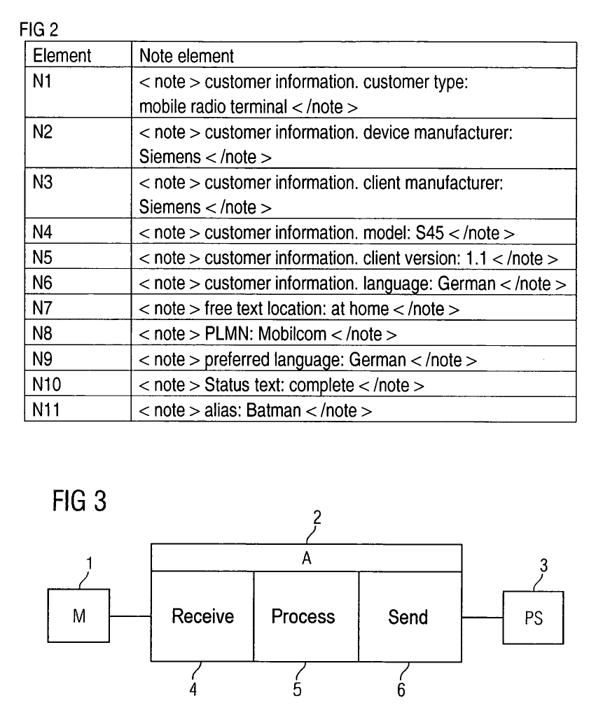

FIG. 2 shows how the attributes in line with the WV standard, which are represented in the form of text character strings, are recorded in note elements. In this exemplary embodiment, the name of the text character string is separated using a colon. The name of the attribute represents an opportunity for clear association. To be able to identify subattributes clearly as well, the main attribute is also separated from the subattribute using a dot “.”. This is necessary since, by way of example, the “language” attribute exists for a plurality of main attributes. Another option would be to define for each WV attribute a dedicated extension of the attribute for the IMS presence information. This would mean that the described presence data format CPIM-PIDF would need to be extended by its tupels. The identifying supplement could be specified within the mobile radio standardization committees (3GPP, OMA, etc.).

FIG. 3 shows a simplified architecture, comprising a mobile radio station 1, a mapping unit 2 and an IMS presence server 3. To be able to support mobile radio terminals 1 which have implemented a presence application in line with the Wireless Village standard, a mapping unit 2 is set up in a mobile communication network. The mapping unit 2 comprises a reception unit 4 for receiving messages in line with the two standards, a processing unit 5 and a transmission unit 6. This mapping unit 2 communicates with the mobile radio terminal via a connection in line with the WV standard and with an IMS presence server 3 in line with the IMS presence standard. The IMS presence standard is defined using the Session Initiation Protocol (SIP) and necessary extensions of the SIP protocol, such as the Event Notification Framework.

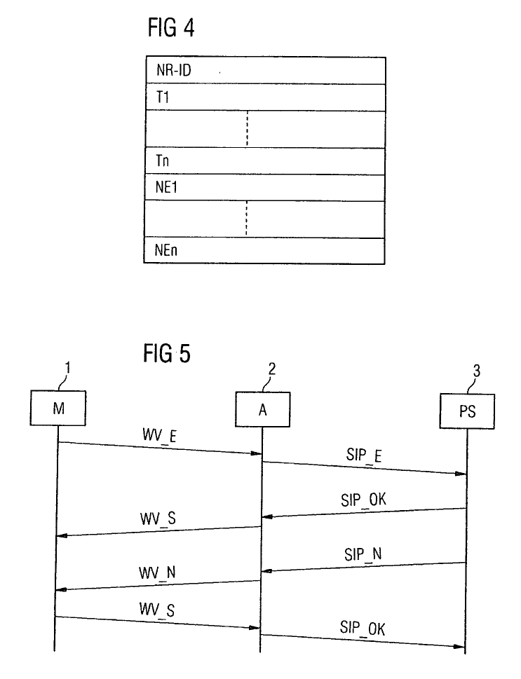

FIG. 4 shows the appearance of the presence information for a user of a mobile radio terminal 1, said presence information being stored on the presence server 3. The field NR-ID includes the identity of the user NR of a mobile radio terminal 1. The fields T₁-Tₙ include the presence tupels. The presence tupels contain the information about the properties of a user of a mobile radio terminal 1, that is to say how the user can be reached, what his present mood is etc. The elements N₁-Nₙ contain the note elements including the text character strings. In this exemplary embodiment, it is assumed that the attributes listed in table A are all included in the note elements. For the sake of simplicity, the address attribute is not used. Use of the address attribute is necessary, by way of example, when the user of a mobile radio terminal 1 is using the presence service in line with the WV standard. The attributes can be stored in the note elements and, as a result, this information can be used for the IMS presence service. The network provider therefore needs to provide an IMS presence server 3.

FIG. 5 shows the sequence for how a mobile radio terminal 1 polls a presence server 3 for presence information. To this end, the mobile radio terminal 1 sends a recording message WV_E in line with the WV standard to a network unit which is in a form such that it recognises the WV message and forwards the message to a mapping unit 2. Having received the message via a reception unit 4, the mapping unit 2 sends an SIP message SIP_E to an IMS presence server 3 using a transmission unit 6. The message is created in a processing unit 5. The IMS presence server 3 confirms recording using an SIP message SIP_OK. Following receipt of this message, the mapping unit 2 sends the mobile radio terminal 1 the WV message “Status”. The mobile radio terminal 1 has thus been successfully registered with the IMS presence server 3.

Next, the IMS presence server 3 sends a notification message SIP_N to the mapping unit 2. This message includes the presence information as shown in FIG. 4. In this case, the note elements are included in the form shown in FIG. 2. The mapping unit 2 knows that the note elements include, at the start, a unique identification (e.g. the name of the attributes) which are separated from the attribute values (text character string) by a separating character (e.g. colon). This allows the mapping unit 2 to create the WV notification message WV_N and to fill the attributes in this notification message with the contents of the note elements. If an attribute name is not recognized by the mapping unit 2, then this note element is created in the form of a WV text attribute. This is the case, by way of example, if the note element includes a text value, such as “<note>chance: Just found my glasses <note>”. Finally, the WV message WV_N is sent to the mobile radio terminal 1, which confirms receipt of the message using a WV_S message. The mapping unit 2, having received this message, creates an SIP message SIP_OK and sends the SIP message to the IMS presence server 3.

What is claimed is:

1. A method for recording presence attributes from a Wireless Village standard in a presence information message from an IP Multimedia Subsystem standard in a mobile communication network, comprising:
recording at least one text character string in a presence attribute from the Wireless Village standard by a mapping unit in a note element in a presence information message from the IP Multimedia Subsystem standard; and
transmitting the presence information message to a presence server and configured for forwarding to additional network units.

2. The method as claimed in claim 1, wherein a text character string recorded in the note element is identified by a supplement relating to an opportunity for clear association with the presence attribute from the Wireless Village standard.

3. The method as claimed in claim 2, wherein the supplement allows the recorded text character string in a note element in a presence information message from the IP Multimedia Subsystem standard to be recorded in a presence information message from the Wireless Village standard.

4. The method as claimed in claim 2, wherein a separating character is provided between the supplement relating to an opportunity for clear association and the recorded text character string.

5. The method as claimed in claim 2, wherein the supplement relating to an opportunity for clear association comprises a name of the presence attribute.

6. The method as claimed in claim 1, wherein the presence information message is a Session Initiation Protocol message.

7. The method as claimed in claim 6, wherein the Session Initiation Protocol message has been extended by an Event Notification Framework.

8. The method as claimed in claim 2, wherein a text attribute in line with the Wireless Village standard is created from a note element if the supplement relating to an opportunity for clear association is not recognized by the mapping unit.

9. An apparatus for recording presence attributes from a Wireless Village standard in a presence information message from an IP Multimedia Subsystem standard in a mobile communication network, comprising:
a reception unit in a mapping unit to receive at least one text character string in a presence attribute from the Wireless Village standard;
a processing unit to record the text character string in a note element in a presence information message; and
a transmission unit to forward the presence information message to a presence server.
